(19) United States
(12) Patent Application Publication
(10) Pub. No.: US 2008/0197625 A1
(43) Pub. Date: Aug. 21, 2008

(54) Garden Hose Coupling and Method of Forming Same

(75) Inventors: Michael E. Allman, Montpelier, OH (US); Young Seo, Ann Arbor, MI (US)

Correspondence Address: FRASER CLEMENS MARTIN & MILLER LLC, 28366 KENSINGTON LANE, PERRYSBURG, OH, 43551, US

(73) Assignee: WINZELER STAMPING COMPANY, Montpelier, OH (US)

(21) Appl. No.: 11/577,376

(22) PCT Filed: Oct. 17, 2005
(86) PCT No.: PCT/US05/37254

§ 371 Date: Apr. 17, 2007

Related U.S. Application Data
(60) Provisional application No. 60/619,840, filed on Oct. 18, 2004.

(51) Int. Cl. F16L 33/00; B23P 11/02

(52) U.S. Cl. 285/259; 29/507

(57) ABSTRACT

A hose coupling and method of forming the same are disclosed, wherein a strength thereof is maximized and a cost of manufacture is minimized. The hose coupling utilizes a plastic ferrule which militates against a hose end being released from the hose coupling during use.

### CROSS-REFERENCE TO RELATED APPLICATION

This application claims the benefit of U.S. Provisional Patent Application Ser. No. 60/619,840, filed on Oct. 18, 2004.

### FIELD OF THE INVENTION

The present invention relates to hose couplings, and more particularly to hose couplings including a plastic ferrule which militates against a hose end being released from the hose coupling during use.

### BACKGROUND OF THE INVENTION

A traditional stamped coupling set consists of a male element or a female element and a ribbed ferrule. All of the elements are typically made of brass. A ribbed ferrule is placed over the outside circumference of a hose, and a tailpiece of the male/female element is inserted into the interior of the hose. A set of expandable fingers is inserted into the tailpiece and then activated, causing the fingers to expand and push the tailpiece outwardly, thereby pinching the hose between the tailpiece and the ribbed ferrule. Traditional couplings utilize fingers which shape the tailpiece in a wave or wrinkled form.

When the coupling having the tailpiece in the wave form is subject to a pull test, the hose quickly loses contact with the tailpiece and the associated ribbed ferrule. When the hose elongation reaches the next corresponding rib of the ferrule, almost no surface area of the hose is sustained up to the next adjacent compressed area.

It is considered to be advantageous if the present coupling structures could be designed to increase the overall strength and simultaneously reduce the cost to manufacture the product.

It would be desirable to produce a garden hose coupling assembly which is of improved strength and is less expensively manufactured.

### SUMMARY OF THE INVENTION

In accordance with the current invention, a hose coupling wherein a strength thereof is maximized and a cost of manufacture is minimized has been surprisingly discovered.

The invention is typically produced by changing the composition and geometry of a ferrule which is used together with a tailpiece of a male or female coupling to compressively retain a section of a hose.

It is one purpose of the invention to embrace a new composition and geometry of the ferrule in order to maintain constant contact between the elements of the coupling and the associated hose. A ferrule in accordance with the current invention maintains a substantially constant inner diameter and acts as a boundary toward which the tailpiece is expanded. Once the expansion of the tailpiece is accomplished, the hose is tightly held in a compressed state between the outer surface of the expanded portion of the tailpiece and the inner surface of the surrounding ferrule.

It is another purpose of the invention to utilize a ferrule made of plastic to reduce the cost of manufacturing.

In one embodiment, the hose coupling comprises: a hollow cylindrical coupling having a first end and a second end, a threaded section formed adjacent the first end, and a tailpiece formed at the second end adapted to be received in an end of a hose; and a hollow plastic ferrule having a radially inwardly extending lip formed at a first end thereof, the ferrule surrounding at least a portion of the tailpiece of the coupling and cooperating with the tailpiece to secure the end of the hose therebetween.

In another embodiment, the hose coupling comprises: a hollow cylindrical coupling having a first end and a second end, the first end including a threaded section for receiving a complimentary threaded section of an associated coupling, the second end including a tailpiece adapted to be received in an end of a hose, the coupling including a shoulder formed between the first end and the second end, and an annular groove formed between the shoulder and the second end of the coupling; and a hollow plastic ferrule having a first end and a second end, the first end having a radially inwardly extending lip which abuts the shoulder of the coupling, an inner surface of the ferrule having a substantially constant diameter, the ferrule surrounding at least a portion of the tailpiece of the coupling and cooperating with the tailpiece to secure the end of the hose therebetween.

The invention also provides methods of forming hose couplings. In one embodiment, the method of forming the hose coupling comprises the steps of: providing a hollow cylindrical coupling having a first and a second end, a threaded section formed adjacent the first end for receiving a complimentary threaded section of an associated coupling, a tailpiece formed at the second end; causing the interior of a hose to be disposed around at least a portion of the tailpiece of the coupling; providing a hollow plastic ferrule having a first end and a second end, the first end of said ferrule terminating in radially inwardly extending lip; causing the hollow plastic ferrule to be disposed around the tailpiece and the hose; and causing the tailpiece of the coupling and to expand outwardly to secure the hose between the tailpiece and the ferrule.

### BRIEF DESCRIPTION OF THE DRAWINGS

The above, as well as other advantages of the present invention, will become readily apparent to those skilled in the art from reading the following detailed description of several embodiments of the invention when considered in the light of the accompanying drawings, in which:

FIG. 1 is a sectional side view of a hose coupling according to an embodiment of the invention;

FIG. 2 is a side view partially in section of a hose coupling similar to the coupling illustrated in FIG. 1 including a female coupling;

FIG. 3 is a side sectional view of a hose coupling according to another embodiment of the invention;

FIG. 4 is a side view partially in section of a hose coupling similar to the coupling illustrated in FIG. 3 including a female coupling.

### DETAILED DESCRIPTION OF THE PREFERRED EMBODIMENTS

The following detailed description and appended drawings describe and illustrate various exemplary embodiments of the invention. The description and drawings serve to enable one skilled in the art to make and use the invention, and are not intended to limit the scope of the invention in any manner. In respect of the methods disclosed and illustrated, the steps presented are exemplary in nature, and thus, the order of the steps is not necessary or critical.

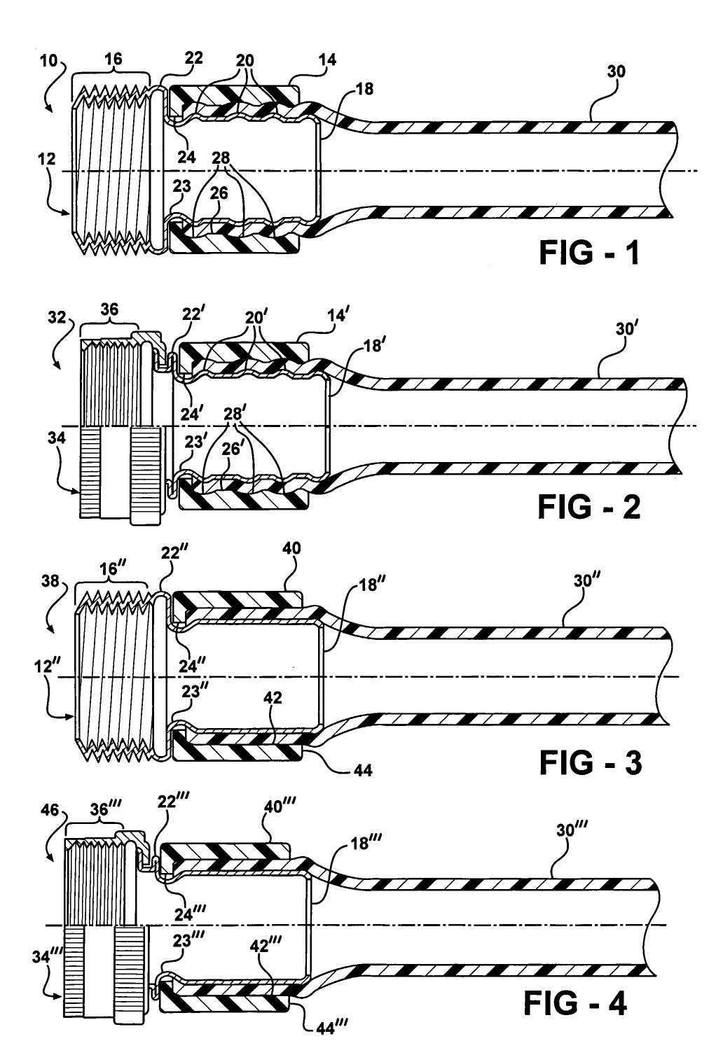

FIG. 1 illustrates a hose coupling 10 consisting of a male coupling 12 and an associated hollow ferrule 14. The male coupling 12 is typically formed of metal, such as brass for example. The male coupling 12 includes a male threaded section 16 formed adjacent a first end thereof for receiving a complimentary threaded section of an associated female coupling (not shown). A tailpiece 18 is formed at a second end of the male coupling 12 and includes a plurality of ribs 20 formed thereon. It is understood that the number of ribs 20 is not regarded as critical. A shoulder 22 is formed between the threaded section 16 and the tailpiece 18. An inwardly extending annular groove 23 is disposed between the shoulder 22 and the tailpiece 18.

The hollow ferrule 14 is positioned to surround the end of an associated hose 30. The ferrule 14 may be formed of a plastic material, such as nylon, for example. A radially inwardly extending lip 24 is formed at a first end of the hollow ferrule 14. An inner surface 26 of the hollow ferrule 14 includes a plurality of grooves 28 formed thereon. It is understood that more or fewer grooves than shown can be used as desired.

The end of the hose 30 is disposed radially between the tailpiece 18 and the hollow ferrule 14. The hose 30 is typically inserted a garden hose, for example. Additionally, the hose 30 can be formed of any conventional material such as rubber, for example.

A method of forming the hose coupling 10 according to the embodiment of the invention shown in FIG. 1 will now be described. The male coupling 12 is provided. The end of the hose 30 is disposed around the tailpiece 18. The hollow ferrule 14 is disposed around the hose 30 and positioned as shown in FIG. 1. The radially inwardly extending lip 24 of the hollow ferrule 14 is caused to abut the shoulder 22 of the male coupling 12.

A tool having a set of expandable fingers (not shown) is inserted into the male coupling 12 and activated. The fingers are cause to expand, thereby causing the tailpiece 18 of the male coupling 12 to expand outwardly toward the hollow ferrule 14 to form the ribs 20 and the annular groove 23. The hose 30 is secured between the tailpiece 18 and the hollow ferrule 14. The lip 24 and the groove 23 cooperate to militate against relative movement between the male coupling 12 and the ferrule 14. It is understood that alternate means of causing the tailpiece 18 to expand and secure the hose 30 can be utilized without departing form the scope of the invention. When the forming tool is removed from the male coupling 12, the hose coupling 10 is assembled on the associated hose 30 and is ready for use.

FIG. 2 illustrates a hose coupling 32 including a female coupling 34. Structure similar to that illustrated in FIG. 1 includes the same reference numeral and a prime (′) symbol for clarity. The female coupling 34 includes a female threaded section 36 for receiving a complimentary threaded section of an associated male coupling (not shown). A method of forming the hose coupling 32 is the same as described for FIG. 1.

FIG. 3 illustrates a hose coupling 38 according to another embodiment of the invention. Structure similar to that illustrated in FIGS. 1 and 2 includes the same reference numeral and a double prime (″) symbol for clarity. The hose coupling 38 includes a male coupling 12″ and an associated hollow ferrule 40. The male coupling 12″ is typically formed of metal such as brass, for example. The male coupling 12″ includes a threaded section 16″ formed adjacent a first end thereof for receiving a cooperating with an associated internally threaded section of an associated female coupling (not shown). A tailpiece 18″ is formed at a second end of the male coupling 12″. A shoulder 22″ is formed between the threaded section 16″ and the tailpiece 18″. An annular groove 23″ is disposed between the shoulder 22″ and the tailpiece 18″.

The hollow ferrule 40 may be formed of a plastic material such as nylon, for example. A radially inwardly extending lip 24″ is formed at a first end of the hollow ferrule 40. An inner surface 42 of the hollow ferrule 40 is smooth and uninterrupted and has a substantially constant inner diameter from the radially inwardly extending lip 24″ to an opposing edge portion 44 thereof.

The method of forming the hose coupling 38 will now be described. The male coupling 12″ is provided. The end of the hose 30″ is disposed around the tailpiece 18″ of the coupling 12″. The hollow ferrule 40 is disposed around a hose 30″ and is positioned as shown in FIG. 3. The radially inwardly extending lip 24″ of the hollow ferrule 40 is caused to abut against the shoulder 22″ of the male coupling 12″.

A tool having a set of expandable fingers (not shown) is inserted into the male coupling 12″ and activated. The fingers are caused to expand, thereby causing the tailpiece 18″ of the male coupling 12″ to expand outwardly toward the hollow ferrule 40. The hose 30″ is thereby secured between the tailpiece 18″ and the hollow ferrule 40. The lip 24″ and the groove 23″ cooperate to militate against relative movement between the male coupling 12″ and the ferrule 40. It is understood that alternate means of causing the tailpiece 18″ to expand and secure the hose 30″ can be utilized without departing form the scope of the invention.

FIG. 4 illustrates a hose coupling 46 including a female coupling 34′″. Structure similar to that illustrated in FIGS. 1, 2, and 3 includes the same reference numeral and a triple prime (′″) symbol for clarity. The female coupling 34′″includes an internally threaded section 36′″ for receiving a complimentary threaded section of an associated male coupling (not shown). The method of forming the hose coupling 46 is the same as described for FIG. 3.

The use of a plastic ferrule provides several advantages over the prior art, including a lower cost of manufacturing than the traditional structure typically utilizes a brass ferrule. In addition to the cost savings, the use of a plastic ferrule allows for variations in color and the addition of trademarks and other indicia on the plastic ferrule which would be attractive in the marketplace.

From the foregoing description, one ordinarily skilled in the art can easily ascertain the essential characteristics of the invention and, without departing from the spirit and scope thereof, can make various changes and modifications to adapt it to various usages and conditions.

1. A hose coupling comprising:
a hollow cylindrical coupling member having a first end and a second end, and a tailpiece formed at the second end adapted to be received in an end of an associated hose; and
a hollow plastic ferrule having a radially inwardly extending lip formed at a first end thereof, said ferrule surrounding at least a portion of the tailpiece of said coupling member and cooperating with the tailpiece to secure the end of the associated hose therebetween.

2. The hose coupling defined in claim 1, wherein an inner surface of said ferrule is substantially uninterrupted.

3-19. (canceled)

20. The hose coupling defined in claim 1, wherein a threaded section is formed adjacent the first end.

21. The hose coupling defined in claim 20, wherein the threaded section of the coupling member includes an externally threaded section.

22. The hose coupling defined in claim 20, wherein the threaded section of the coupling member includes an internally threaded section.

23. The hose coupling defined in claim 1 wherein an annular groove is formed in said coupling member.

24. The hose coupling defined in claim 23 wherein the lip of said ferrule cooperates with said annular groove to militate against relative movement between said hollow cylindrical coupling member and said ferrule.

25. The hose coupling defined in claim 1, wherein said ferrule contains an interior surface which includes at least one groove formed thereon.

26. The hose coupling member defined in claim 25, wherein said coupling contains at least one rib thereon.

27. The hose coupling defined in claim 26, wherein said rib cooperates with the grooves of said coupling member to secure the end of the associated hose therebetween.

28. The invention defined in claim 1, wherein the radially inwardly extending lip abuts against a shoulder formed on said hollow cylindrical coupling member.

29. A hose coupling member comprising:
a hollow cylindrical coupling having a first end and a second end, the second end including a tailpiece adapted to be received in an end of a hose, said coupling including a shoulder formed between the first end and the second end, and an annular groove formed between the shoulder and the second end of said coupling member; and
a hollow plastic ferrule having a first end and a second end, the first end having a radially inwardly extending lip which abuts the shoulder of said coupling member, an inner surface of said ferrule is uninterrupted, said ferrule surrounding at least a portion of the tailpiece of said coupling and cooperating with the tailpiece to secure the end of the hose therebetween.

30. The hose coupling defined in claim 29, wherein a threaded section is formed adjacent the first end for receiving a complimentary threaded section of an associated coupling.

31. The hose coupling defined in claim 30, wherein the threaded section of said coupling member is external.

32. The hose coupling defined in claim 30, wherein the threaded section of said coupling member is internal.

33. The hose coupling defined in claim 29, wherein the lip of said ferrule cooperates with the annular groove to militate against relative movement between said hollow cylindrical coupling member and said ferrule.

34. The hose coupling defined in claim 33, wherein the lip of said ferrule cooperates with the annular groove to militate against relative movement between said hollow cylindrical coupling member and said ferrule.

35. A method of forming a hose coupling including the steps of:
providing a hollow cylindrical coupling having a first end and a spaced apart second end, a tailpiece formed at the second end;
causing at least a portion of the tailpiece of the coupling member to be inserted into the interior of the a hose;
providing a hollow plastic ferrule having a first end and a spaced apart second end, the first end of said ferrule terminating in radially inwardly extending lip;
causing the hollow plastic ferrule to be disposed around the tailpiece and the hose; and
causing the tailpiece of the coupling member and to expand outwardly to secure the hose between the tailpiece and the ferrule.

36. The method according to claim 35, wherein the portion of the hollow plastic ferrule disposed about the Lailpiece and the hose has a substantially uninterrupted inner surface.

37. The method according to claim 35, further comprising the step of inserting a tool to expand the coupling member outwardly toward the ferrule to secure the hose therebetween.
